(19) United States
(12) Patent Application Publication
(10) Pub. No.: US 2009/0017249 A1
(43) Pub. Date: Jan. 15, 2009

(54) Antistatic Tapes and Method for Producing Thereof

(76) Inventors: Kwang Suck Suh, Seongnam-Si (KR); Jong Eun Kim, Seoul (KR); Tae Young Kim, Seoul (KR); Yun Sang Kim, Seongnam-Si (KR)

Correspondence Address: PARK LAW FIRM, 3255 WILSHIRE BLVD, SUITE 1110, LOS ANGELES, CA, 90010, US

(21) Appl. No.: 10/575,984

(22) PCT Filed: Oct. 15, 2004
(86) PCT No.: PCT/KR04/02641

§ 371 Date: Apr. 17, 2006

(30) Foreign Application Priority Data
Oct. 15, 2003 (KR) 10-2003-0071945

(51) Int. Cl. B32B 7/10; B05D 5/10

(52) U.S. Cl. 428/41.8; 428/343; 427/207.1; 427/208

(57) ABSTRACT

The present invention relates to a method for producing an antistatic adhesive tape. More particularly, the present invention relates to an adhesive tape in which one surface of the tape can have a surface resistivity in the range of 10⁶-10¹¹Ω/□ by forming a conductive polymer-based antistatic layer on the surface, and the opposite surface can have a controllable surface resistivity in the range of 10³-10¹⁰Ω/□ by forming a conductive polymer-based hard coating layer on the opposite surface, and at the same time, has excellent resistance, to various solvents. The adhesive tape produced by the inventive method does not cause static electricity when it is detached from the surface of electronic parts or films to which it had been attached. Also, the tape has an excellent antistatic property on its surface when it is stuck or attached to the electronic part or film surface. Also, it has excellent resistance to various solvents.

### TECHNICAL FIELD

The present invention relates, in general, to a protective tape with an antistatic property and a hard-coating property, which can be used on the surface of electronic parts and various films. More particularly, the present invention relates to a method for producing a protective tape in which static electricity does not occur when the tape is detached from the surface of electronic parts or films having the protective tape attached thereto, and which is excellent not only in antistatic property on a surface having the tape attached thereto but also in resistance to various solvents, as well as a protective tape produced thereby.

### BACKGROUND ART

With regard to precise electronic parts and films for display devices, a sticky or adhesive (hereinafter “adhesive”) tape is generally used to protect the expensive electronic parts and films. Since this tape generally has an adhesive property, it is attached to the surface of said parts or films and then detached from the surface before the use of the parts and films. In the procedure of detaching the tape from the surface to which the tape had been attached, there are problems in that either static electricity occurs so that surrounding dust sticks to the tape surface, and/or static charges remaining on the tape surface break a glass substrate or cause damage to other parts.

In order to solve such problems, in the prior art, an antistatic agent consisting of a cationic, anionic or non-ionic surfactant was applied on the tape surface, or carbon blacks, metal particles or metal oxides were coated on the tape surface. However, such tapes have problems in that they are very limited in use since they greatly depend on water content, are not permanent, or cause damage to parts due to the generation of black or conductive impurities. Thus, a need for the invention of a new tape exists.

In order to solve such problems, conductive polymers may be used. For example, Korean Patent No. 10-0390527 discloses that, in a tape produced by coating an antistatic coating solution containing a conductive polymer on one surface of a polyimide film, forming an adhesive layer on the opposite surface of the polyimide film and then winding the resulting film, static electricity does not occur during a procedure of unwinding the tape. However, although the adhesive tape produced by this technology can prevent static electricity from occurring during the procedure of unwinding the wound tape, it has a problem in that it cannot prevent static electricity from occurring on the adhesive surface when it is detached from the surface of electronic parts or films having the tape attached thereto. Furthermore, although the antistatic layer formed by this technology can be formed by hard-coating with organic or inorganic silicates, the production of the hard coating layer has a problem in that it requires a high temperature curing process at a temperature of at least about 120° C. When a curing process is performed at a low temperature of 60-70° C., it requires a long period of time of about 24-100 hours and causes a reduction in solvent resistance. Particularly in the case of an adhesive tape including a film of polymers, such as polyethylene or polystyrene polymers, which cannot be treated at high temperature, the use of the above technology necessarily requires the low curing temperature, thus reducing the solvent resistance of the tape product.

Accordingly, there is a need for the invention of a new tape which is easily cured at low temperature by, for example, a UV-curing method, shows excellent resistance to solvents, such as toluene, methyl ether ketone, ethyl acetate, acetone or alcohol, has excellent antistatic performance, and does not cause static electricity on the adhesive surface even when it is detached from the surface of electronic parts or films to which it has been attached.

### DISCLOSURE

### Technical Problem

Accordingly, studies with relation to an adhesive tape which overcomes the above-mentioned shortcomings are needed. Namely, an adhesive tape is needed in which static electricity does not occur even when the tape is attached to or detached from the surface of electronic parts, and in which the solvent resistance of the opposite surface of the tape is excellent while the antistatic property of both surfaces can be permanently maintained.

### Technical Solution

An object of the present invention provides a permanent antistatic adhesive tape in which one surface of the tape can have a surface resistivity in the range of 108-10¹¹ ohms/square (Ω/□) by forming a conductive polymer-based antistatic layer on the surface and an adhesive layer thereon, and the opposite surface can have a controllable surface resistivity in the range of 10³-10¹⁰Ω/□, by forming a conductive polymer-based hard coating layer on the opposite surface, and at the same time, has excellent resistance to various solvents.

### ADVANTAGEOUS EFFECTS

The adhesive layer in the adhesive tape according to the present invention can have a controllable surface resistivity in the range of 10⁸-10¹¹Ω/ and does not cause static electricity when the tape is detached from a surface of the parts to which it had been stuck or attached. Also, the antistatic hard coating layer formed on the surface opposite to the adhesive layer can have a controllable surface resistivity in the range of 10³-10¹⁰Ω/ and has excellent resistance to various solvents. Thus, the adhesive tape according to the present invention can permanently maintain its antistatic property on both surfaces.

### DESCRIPTION OF DRAWINGS

FIG. 1 is a cross-sectional view of an antistatic adhesive tape according to a preferred embodiment of the present invention.

### BEST MODE

In order to achieve the above object, the present invention provides an antistatic adhesive tape comprising a base film and, on one surface of the base film, 1) a conductive polymer-based conductive layer and an adhesive layer formed on the conductive layer, or 2) a layer formed of a mixture of a conductive polymer and an adhesive agent.

Also, the present invention provides an antistatic adhesive tape with hard coating property comprising a base film and, on one surface of the base film, 1) a layer formed by hard-coating a mixture of a conductive polymer and a UV curing agent, or 2) a conductive polymer-based conductive layer and a UV curing layer on the conductive layer as a protective layer.

Also, the present invention provides a method for producing an antistatic adhesive tape, which comprises, on one surface of a base film, either forming a conductive polymer-based antistatic layer and then applying an adhesive agent, or applying a mixture of a conductive polymer and an adhesive agent.

Also, the present invention provides a method for producing an adhesive tape, which comprises one surface of a base film, either forming a conductive polymer-based antistatic layer and then coating a protective layer formed of a curing agent containing a UV-curable binder, or hard-coating a mixture of a conductive polymer and a UV-curable binder, so as to impart antistatic and hard coating properties to the tape.

Hereinafter, the present invention will be described in more detail with reference to the accompanying drawing.

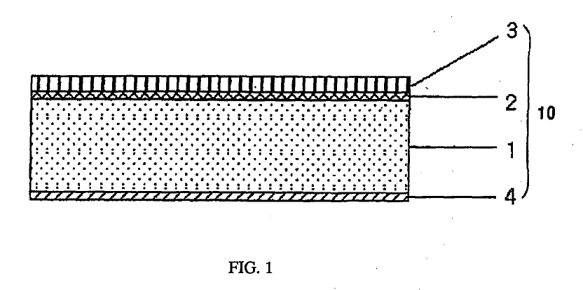

FIG. 1 is a cross-sectional view of an antistatic adhesive tape according to a preferred embodiment of the present invention. As shown in FIG. 1, an adhesive tape 10 according to the present invention includes a base polymer film 1. On one surface of the base polymer film 1, a conductive polymer-based antistatic layer 2 is formed, and on the surface of the antistatic layer 2, an adhesive layer 3 is formed. Also, on the opposite surface of the base polymer film 1, an antistatic layer 4 containing a conductive polymer is formed.

Examples of a polymer which can be used to form the base film 1 of the adhesive tape 10 include almost all polymers, such as ethylene, propylene, ester, acrylic, imide, amide, and styrene polymers. Also, the base film 1 may be made of a blend or copolymer of such polymers, or may be a laminated film formed by laminating films having the respective polymers.

The antistatic layer 2 in FIG. 1 may be formed by various methods. The most preferred method for forming the antistatic layer 2 comprises applying a conductive polymer-containing antistatic coating solution on the film surface and drying the applied layer. If necessary, a curing agent-containing antistatic coating solution may also be used.

In the above method, the antistatic coating solution is prepared by mixing 0.1-20 parts by weight of a conductive polymer, 10-50 parts by weight of an adhesive binder, 0.01-10 parts by weight of a surfactant serving to facilitate the dispersion of such components, and 20-88.89 parts by weight of a solvent. In addition, if necessary, the use of a thickener or a curing agent, such as organic or inorganic silicate, melamine, isocyanate, or weak acid, can provide the effect of an increase in the solvent resistance of the formed antistatic layer. Particularly if an adhesive agent dissolved in a solvent such as toluene is applied on the surface of the antistatic layer 2, the antistatic layer must have excellent solvent resistance. For this reason, the use of a curing system is very effective since it does not cause damage to the antistatic layer upon the formation of an adhesive layer.

The conductive coating solution prepared as described above is coated on one surface of the base film 1 to a thickness of 0.001-5 μm by a coating method selected from gravure, reverse gravure, kiss bar, knife, bar coater or comma coating methods. The coated layer is dried at a temperature of 40-200° C. for 1-20 minutes to volatilize the solvent, thus forming the conductive antistatic layer 2.

The most important component of the conductive coating solution is the conductive polymer for imparting conductivity. Examples of a conductive polymer which can be used in the present invention include all conductive polymers, such as polyaniline, polythiophene, polypyrrole and the like. Also, a modified conductive polymer may be used and examples thereof include, but are not limited, polyaniline substituted with a sulfonyl group, polythiophen substituted with an alkyl group of 4-10 carbon atoms, polythiophene substituted with a 3,4-ethylenedioxy group, and the like.

The solvent used in the present invention is one selected from the group consisting of methyl alcohol, ethyl alcohol, isopropyl alcohol, normal butanol, water, toluene, xylene, 1-methyl-2-pyrrolidinone, chloroform, ethyl acetate, and 2-methoxy ethanol. Also, a mixture of two of thease solvents may be used at a mixing ratio of 5:95-95:5.

In coating the conductive coating solution on the surface of the base film, the conductive material must be mixed with a binder. As the binder, any binder may be used if it has a glass transition temperature of −40° C. or more. Examples of binders which meet this condition include acryl, urethane, ester, ether, epoxy, amide, imide, carboxyl acid, hydroxyl, styrene, cellulose, and cyclic olefin resins. Also, a mixture of two or more of these binders may be used such that the reaction can be induced during drying and curing. Binders having a glass transition temperature lower than the above-mentioned temperature cannot be used since the coated surface will be so smooth that it can be pushed by hand.

Also, in coating the conductive coating solution on the surface of the base film 1, the interfacial tension of the surface of the base film 1 is very important. The conductive coating solution is easily coated if the interfacial tension is more than 35 dynes/cm². For example, in the case of a polymer film with low interfacial tension, such as a polyethylene, polypropylene, or polystyrene film, it is sufficient if its surface is corona-treated to have an interfacial tension of at least 35 dynes/cm². If the surface is not corona-treated, a chlorinated resin-containing primer for polyethylene or polypropylene can first be coated on the surface and then the conductive coating solution can be coated on the primer layer, thus forming a conductive layer with very excellent adhesive strength. Concrete examples of the primer made for this purpose include “Super PE” (made by Samhwa Paint Industrial Co., Ltd., Korea). If a mixture of two or more of the binders is used or the primer and the binder are compatible with each other despite they are different, increased in adhesion strength can be likewise obtained. Also, if the binder or primer component is previously mixed with the base polymer, the same effect as that of the primer treatment can be obtained.

If the antistatic layer 2 needs to be cured, it can be cured by a mixture of the binder and a curing agent. Typical examples of the curing agent are melamine and isocyanate for use with urethane and acrylic binders, and those for use with an ester binder. The content of the curing agent is preferably 0.1-5 parts by weight relative to the above binder content, although it varies depending on the curing degree and curing time. This is because a curing agent content of less than 0.1 parts by weight shows an insufficient curing effect, and a curing agent content of more than 5 parts by weight does not show a further increase in the curing effect.

In addition, the antistatic layer 2 may also be formed on the base film 1 by producing the conductive polymer directly on the film surface, i.e., by an interfacial polymerization method. In this case, a method can be used in which the base film is immersed in or applied with a solution containing monomers for forming the conductive polymer, an oxidizing agent, a dopant, and, if necessary, a polymerization inhibitor, and then heated so as to synthesize the conductive polymer directly on the film surface, after which substances remaining on the film surface are washed off. Alternatively, another method with the same effect as the former method can be used in which a mixture of a binder with an oxidizing agent, a dopant, or both is first applied on the base film surface, and then monomers for synthesizing the conductive polymer are brought into contact with the applied mixture so as to form a conductive polymer layer, after which substance remaining on the film surface are washed off.

Since this interfacial polymerization method has a problem in that substances remaining after the synthesis of the conductive polymer need to be washed off with a solvent such as water or alcohol, this method is inconvenient compared to the method using the conductive polymer coating solution. However, this method is very effective when the antistatic layer must have a low surface resistivity of about 10²-10³Ω/□.

The adhesive layer 3 is finally formed by applying a known silicone, acrylic, or epoxy adhesive agent on the surface of the antistatic layer 2 formed by the above-described method. In other words, after forming the antistatic layer 2 using the conductive polymer, the adhesive agent is applied to the formed antistatic layer 2 to form the adhesive layer 3, so that the conductivity of the underlying antistatic layer 2 is transferred to the surface of the adhesive layer 3, thus imparting an antistatic property to the surface of the adhesive tape 10. The adhesive agent is preferably applied on the antistatic layer in a thickness of 0.001-30 μm, and preferably 0.1-30 μm.

In addition to the above-described method, an adhesive agent having good compatibility with the conductive polymer may also be used to impart an antistatic property, in which case the compatibility between the conductive polymer and the adhesive agent must be considered. As the adhesive agent used in a mixture with the conductive polymer, almost all kinds of adhesive agents, such as epoxy, acrylic, urethane, modified acrylic, modified urethane, modified elastomer resins and the like, may be used. Using such an adhesive agent, an adhesive composition is adhered by applying heat and pressure separately or simultaneously. Because the use of an excessive amount of the conductive polymer causes a reduction in adhesive strength, the conductive polymer content preferably does not exceed 20% relative to the total solid content in the adhesive composition.

In the adhesive tape 10 formed as described above, although the antistatic layer 2 is formed on one surface of the base film 1 and the adhesive layer 3 is formed on the antistatic layer 2, it is preferable that an antistatic layer should also be formed on the opposite surface of the base film 1. The antistatic layer 4 may be formed in the same or similar manner as the antistatic layer 2. However, since the antistatic layer 4 is exposed to the surface after attaching the adhesive tape, it preferably has properties, such as resistance against dust attachment, scratch development from handing, or damage from a solvent wash.

In order to impart these properties, the heat-curable hard coating method disclosed in the prior patent literature may also be used. However, as described above, if a polymer film with low heat resistance, such as a polyethylene film or the like, is used as the base film, there will be a problem in that heat curing needs to be performed at low temperature for a long period of time. To overcome this problem, the antistatic layer is preferably formed as an antistatic hard coating layer by a UV-curable antistatic hard coating method.

An antistatic composition for hard-coating the antistatic layer 4 shown in FIG. 1 is prepared by mixing 10-40 parts by weight of a conductive polymer, 30-50 parts by weight of a UV-curable binder, 0.5-5 parts by weight of a photoinitiator, 0.1-5 parts by weight of a surfactant, 0.1-2 parts by weight of a UV stabilizer, and 20-59.3 parts by weight of a solvent.

As a conductive polymer in the hard coating antistatic composition, the same conductive polymer used in the antistatic layer 2 may be used. As the UV-curable polymer binder, an acrylate monomer may be used alone or in a mixture with an acrylate oligomer. Alternatively an acrylate monomer with at least two functional groups may be used alone or in a mixture with a given amount of oligomeric acrylate resin. If the acrylate monomer is used alone, the resulting antistatic layer will be too brittle, but if the acrylate monomer is used in a mixture with a suitable amount of the oligomeric acrylate, the resulting antistatic layer will have a good coating hardness and be a good surface layer. Regarding cautions in selecting the UV-curable binder, the adhesive tape is mostly used after it has been applied with the adhesive agent and then wound into a given form. For this reason, the UV-curable binder must be selected in such a manner that the UV-curable binder does not detach due to sticking to the adhesive agent. Thus, if a general-purpose hard coating agent is used as the UV-curable binder it is preferable that a silicone or fluorine-based component with a release property should be used as a surfactant, and the polymer binder has the release property (i.e., contains a silicone or fluorine group).

As a photoinitiator, a solid photoinitiator is used since a liquid photoinitiator can interfere with UV curing. Typical examples of the photoinitiator include benzyl dimethyl ketal, hydroxy cyclohexyl phenyl ketone, hydroxy dimethyl acetophenone, benzophenone, and 2,4,6-trimethylbenzoyldiphenylphosphine. The surfactant is used to disperse the components uniformly, and a fluorine- or silicone-based surfactant is mainly used as the surfactant. The fluorine-based surfactant is particularly effective since it acts to lower the refraction index of the final product. The UV stabilizer is used to suppress the possibility of a reduction in the conductivity of the conductive polymer, which is caused by the breakdown of conjugated double bonds which can occur upon the exposure of the conductive polymer to UV. Examples of the UV stabilizer which can be used in the present invention include various UV stabilizers, such as 2,4-dihydroxybenzophenone, 2-hydroxy-4-n-oxtyloxybenzophene, ethyl-2-cyano-3-diphenylacrylate and the like. Examples of the solvent which can be used in the hard coating antistatic composition include alcohol solvents with 1-4 carbon atoms, such as methanol, ethanol, isopropanol, propanol, butanol, and isobutanol, amide solvents, such as N-methyl-2-pyrrolidone, 2-pyrrolidone, N-vinyl-2-pyrrolidone, N-methylformamide, and N,N′-dimethylformamide, and polyhydric alcohol ether solvents, such as ethylene glycol, glycerol, ethylene glycol monomethylether, ethylene glycol monoethylether, and ethylene glycol monobutylether. Such solvents can be used alone or in a mixture of two such solvents with a mixing ratio of 5:95-95:5.

The hard coating antistatic composition is applied on the surface of the base film in a thickness of 10 nm-5 μm by a method selected from gravure, reverse gravure, comma, roll coating, or bar coating methods, or a combination of two or more thereof. Next, the applied layer is dried and passed through a UV curing system, thus forming an antistatic hard coating layer.

The adhesive tape according to the present invention does not cause the generation of static electricity even when it is detached from the surface of an object to which it had been attached. Also, the surface resistivity of the adhesive layer in the adhesive tape can be controlled in a surface resistivity range of 10⁶-10¹¹Ω/□. Also, the opposite hard coated surface of the tape, which is opposite to the adhesive layer, has a controllable surface resistivity in the range of 10³-10¹⁰Ω/□, and has excellent solvent resistance such that it is not removed by almost all solvents, such as alcohol, toluene, methyl ether ketone, ethyl acetate, acetone and the like.

The antistatic tape produced by the above-described method may be used in tape form after an adhesive surface had been wound without any further treatment. Alternatively, the antistatic tape may be used after sticking a release film thereto. When a release film is used, the antistatic tape can be attached to the surface of objects after removing the release film from the antistatic tape. In this case, if one surface of the release film is treated with a releasing agent, and the other surface of the release film is applied with a conductive polymer-containing antistatic solution, an antistatic tape to which a release film having no attached impurities can be produced.

The antistatic adhesive tape according to the present invention may be used as it is or after attaching or bonding to one surface of another film, so as to produce a permanent antistatic film for protecting electronic parts, such as LCDs.

Hereinafter, the present invention will be described in more detail by way of examples. It is to be understood, however, that these examples are given for illustrative purpose only and are not intended to limit the scope of the present invention.

### EXAMPLE 1

10 g of 3,4-polyethylenedioxythiophene dispersion, 30 g of 30% methoxymethylamide solution, 0.2 g of para-toluenesulfonic acid, 0.01 g of Zonyl (Dupont Co.), and 0.2 g of ethylene glycol were dissolved in 60 g of a mixture solution of ethyl alcohol and isopropyl alcohol. The resulting solution was coated on a polyester film then dried at 100° C. for 2 minutes. The film thus produced had a surface resistivity of 10⁵Ω/□ and an adhesion of 5 B as measured according to an ASTM D3359 standard test method. Also, the produced film was 98% transparent at wavelength of 550 nm. After the film was coated with an adhesive component and left to stand for 5 days, it showed a resistivity of 10⁵Ω/□.

Also, an epoxy adhesive layer was formed on the produced conductive polymer layer in a thickness of 5 μm. The surface resistivity of the adhesive layer was measured to be 10⁸Ω/□.

### EXAMPLE 2

3.5 mmol of 3,4-ethylenedioxythiophene, 8.1 mmol of ferric toluenesulfonate, and 2.3 mmol of ethanol were dissolved in 15 g of ethanol. The solution was coated on a polyester film in a thickness of 1.5 μm then placed in a heat-circulating oven at 100° C. for 2 minutes so as to induce a reaction. After completion of the reaction, the film was taken out of the oven and its surface was washed with ethyl alcohol and dried, thus producing a transparent antistatic film. The produced film showed a surface resistivity of 10³Ω/□.

Also, an epoxy adhesive layer was formed on the produced conductive polymer layer with a thickness of 5 μm. The surface resistivity of the adhesive layer was measured to be 10⁸Ω/□.

### EXAMPLE 3

5 parts by weight of ferric toluenesulfonate serving as both an oxidizing agent and a dopant was dissolved in 95 parts by weight of n-butanol. The solution was coated on a polyester film and then dried in an oven at 80° C. for about 1 minute. The resulting film coated with both the oxidizing agent and the dopant was allowed to react in a closed chamber in which a vaporous mixture solution of a 3,4-ethylenedioxythiophene monomer and ethanol had been saturated. At this time, the 3,4-ethylenedioxythiophene monomer and the ethanol were used at a mixing ratio of 5:5. The temperature within the chamber was about 50° C., and the reaction time was about 5 minutes. Under such reaction conditions, a conductive polymer film was produced. The produced conductive polymer film showed a surface resistivity of 10⁵Ω/□.

Also, an epoxy adhesive layer was formed on the produced conductive polymer layer in a thickness of 5 μm. The surface resistivity of the formed adhesive layer was measured to be 10⁹Ω/□.

### EXAMPLE 4

30 parts by weight of a polyethylenedioxythiophene dispersion (Baytron PH, Bayer) and 20 parts by weight of a UV curable hard coating agent (UC150H, Uray, Korea) which was dissolved in 70 parts by weight of isopropyl alcohol. The solution was coated on the surface of a polyester film, which was opposite to a surface applied with an adhesive agent. The coated material was dried at 60° C. for 1 minute and then cured in a UV coater.

The produced film had a surface resistivity of 10⁷Ω/□. When the produced film was rubbed 20 times with cleanpaper saturated with acetone, there is no damage to the surface of the film.

### EXAMPLE 5

10 g of 3,4-ethylenedioxythiophene (Baytron PH, Bayer Gmbh, Germany), 29 g of an urethane binder (U710, ALBERDINGK, Germany), 1 g of a melamine curing agent, 0.5 g of ethylene glycol, 0.5 g of N-methylpyrrolidone, and 0.01 g of a fluorine-based surfactant were mixed in isopropyl alcohol to a total of 100 parts by weight. The resulting dispersion was coated on the surface of a polyester film, opposite to the surface applied with an adhesive agent. On the coated material, a UV curing agent (UC150H, Uray, Korea) was coated as a protective coating layer in a thickness of 1 μm. The resulting film was dried at 60° C. for 1 minute and then cured in a UV coater.

The produced film showed a surface resistivity of 10⁷Ω/□ and a hardness of 2H.

1. An antistatic adhesive tape comprising a base film and, on one surface of the base film, either a conductive polymer-based conductive layer and an adhesive layer formed on the conductive layer, or a layer formed of a mixture of a conductive polymer and an adhesive layer.

2. An antistatic adhesive tape with antistatic and hard coating properties, which comprises a base film and, on one surface of the base film, either a layer formed by hard-coating a mixture of a conductive polymer and a UV curing agent, or a conductive polymer-based conductive layer and a UV curing layer on the conductive layer as a protective layer.

3. The antistatic adhesive tape of claim 1, which further comprises a conductive polymer-based antistatic layer on the opposite surface of the base film.

4. The antistatic adhesive tape of claim 3, wherein in order to impart a hard coating property to the antistatic layer on the opposite surface, a UV curing agent is coated on the antistatic layer to form a protective layer, or the antistatic layer is formed by hard-coating a mixture of a conductive polymer and a UV curing agent.

5. A method for producing an adhesive tape, which comprises, on one surface of a base film, either forming a conductive polymer-based antistatic layer and then applying an adhesive agent on the formed antistatic layer, or applying a mixture of a conductive polymer and an adhesive agent.

6. A method for producing an antistatic adhesive tape, which comprises, on one surface of a base film, either forming a conductive polymer-based antistatic layer and then forming a protective layer formed of a curing agent containing a UV-curable binder, or hard-coating a mixture of a conductive polymer and a UV-curable binder, so as to impart antistatic and hard coating properties to the tape.

7. The method of claim 5, which additionally comprises forming a conductive polymer-based antistatic layer on the opposite surface of the base film.

8. The method of claim 7, which comprises, on the antistatic layer formed on the opposite surface, either forming a protective layer formed of a UV-curing agent containing a UV-curable binder, or hard-coating a mixture of a curing agent, a conductive polymer and a UV-curable binder, so as to impart a hard coating property to the antistatic layer.

9. The method of claim 7, wherein in order to form the protective layer on the antistatic layer on the opposite surface, a heat-curable binder and a curing agent are added to the conductive polymer, or the conductive polymer is applied on the antistatic layer and then a heat-curable coating agent containing a heat-curable binder is applied.

10. The method of claim 8 or 9, wherein the heat-curable binder or the UV-curable binder contains a component with a release property.

11. The method of any one of claims 7 to 9, wherein a surfactant with a release property is used in the antistatic layer on the opposite surface so that an adhesive agent does not adhere to the antistatic layer.

12. The method of any one of claims 5 to 8, wherein the conductive polymer is selected from the group consisting of polythiophene, polyaniline, polypyrrole, and 3,4-polyethylenedioxythiophene, and derivatives thereof.

13. The method of any one of claims 5 to 8, wherein the antistatic layer is formed by coating a composition containing a conductive polymer solution and a binder as main components the one surface of the base film.

14. The method of any one of claims 5 to 8, wherein the antistatic layer is formed by polymerizing a mixture of monomers, an oxidizing agent and a dopant directly on the base film so as to synthesize a conductive polymer.

15. The method of any one of claims 5 to 8, wherein the antistatic layer is formed by a vapor phase polymerization method in which an oxidizing agent and a dopant are coated on the base film, and then vapor phase monomers are brought into contact with the coated materials.

16. The method of any one of claims 5, 7 and 8, wherein the adhesive agent is coated in a thickness of 0.001-30 μm.

17. The method of any one of claims 5 to 8, wherein the base film is made of a polymer selected from polyethylene, polyester, polyimide, polystyrene, polyether, polyethersulfone, polyacryl (methacryl), cellulose polymers, cyclic olefin polymers and copolymers thereof.

18. An adhesive tape produced by a method set forth in any one of claims 5 to 8.

19. The adhesive tape of claim 18, which further comprises an antistatic treated release film attached to one surface of the tape.

20. A film with a permanent antistatic property for protecting electronic parts, such as LCDs, which is produced using the tape of claim 18.
